(19) United States
(12) Patent Application Publication
(10) Pub. No.: US 2008/0003342 A1
(43) Pub. Date: Jan. 3, 2008

(54) Semi-Processed Product for Preparing Deep-Frozen Desserts and Deep-Frozen Desserts Made With Said Semi-Processed Product

(76) Inventor: Laura Bravo, Montecchio Maggiore (IT)

Correspondence Address: IP STRATEGIES, 12 1/2 WALL STREET, SUITE I, ASHEVILLE, NC, 28801, US

(21) Appl. No.: 11/569,394

(22) PCT Filed: May 24, 2005
(86) PCT No.: PCT/EP05/52382

§ 371 Date: May 7, 2007

(30) Foreign Application Priority Data
May 24, 2004 (IT) VI2004A000127

(51) Int. Cl. A23G 9/00; A23G 9/32

(52) U.S. Cl. 426/567; 426/659

(57) ABSTRACT

A semi-processed product for the preparation of deep-frozen desserts having creaminess and softness characteristics at temperatures below zero is disclosed, preferably in the range between −15° C. and −25° C., comprising: monosaccharides in a percentage range between 60% and 80%; sweeteners in a percentage range between 5% and 15%; milk proteins in a percentage range between 5% and 10%; vegetable fibres in a percentage range between 0.5% and 5%. The percentage values are based on the total weight of the semi-processed product.

This invention refers to a semi-processed product for preparing deep-frozen desserts.

The invention also regards deep-frozen ice-cream and confectionery desserts made using the above-mentioned semi-processed product.

It is well-known that deep-frozen desserts, like for instance cakes, ice-creams and various types and kinds of sweets, are made by combining and mixing ingredients of different characteristics of flavour, texture and colour, based on the finished product one intends to make.

Therefore, the deep-frozen desserts of the known type are made by selecting the ingredients to be then mixed and kneaded with cream or milk at the manufacturing stage of the product.

Thus, several ingredients must be handled, and this involves the disadvantage that the worker may make mistakes by confusing one ingredient for another or mistaking the proportions of the ingredients.

Furthermore, moving, weighing and mixing a large number of ingredients lengthens the production time.

Another well-known fact is that in order to maintain the edibility of the manufactured product for a long period of time, said product is deep-frozen and stored in suitable freezers with temperatures ranging from −15° C. to −25° C.

The freezing process causes structural alterations in the product wherein:
part of the water present in the mixture and used for preparing it, solidifies and turns into ice;
the amount of water that does not freeze maintains its function as a solvent for the soluble components of the mixture;
the concentration of the solution, in which the soluble ingredients in the product are found, increases;
the osmotic pressure increases.

These alterations determine and influence the consumer's sensorial perception because the presence of, and especially the size of, the ice crystals, that form during the freezing process, create an unpleasant sensation of cold and hardness of the product at the moment of tasting.

To remedy such a drawback, deep-frozen desserts are produced in which, by using certain types of ingredients, it is possible to keep the product sufficiently soft and creamy also when deep-frozen.

In this way the product is easily handled, once removed from the freezer, and may therefore be easily divided into portions, served and eaten, without having to wait for it to soften.

Moreover, when tasted it does not generate for the consumer the aforementioned unpleasant sensation of cold and hardness.

A known mixture of ingredients for a deep-frozen dessert with creaminess characteristics and that may thus be served and eaten immediately after removal from the freezer, essentially comprises:
milk proteins;
sweeteners, like for example dextrose, fructose or other;
monosaccharides, like for example dextrose, fructose or other;
polyols or glycerol additives;
further ingredients, like for instance milk, eggs, flavours, and others, alternatively or in combination, in varying percentages according to the desired final product.

The polyols in particular add creaminess characteristics to the product even at temperatures in the range between −15° C. and −25° C.

A known drawback from the use of said polyols consists in the fact that they are hard to digest and they also have a laxative effect, especially if present in large quantities.

For these reasons, in some known types of deep-frozen desserts the polyols are substituted by vegetable oils that do not have said characteristics of being hard to digest or having a laxative effect.

However, the vegetable oils have the drawback of giving the finished product an aftertaste which may not appeal to the consumers.

Yet another drawback consists of the fact that in order to add structural stability to the finished product it is necessary to add stabilizers such as carob, alginate, carrageenan or guar to the mixture, which inevitably bring higher costs and longer processing time for the preparation of the mixture.

The present invention aims at eliminating all of said drawbacks.

It is especially a main object of the invention to obtain a semi-processed product for preparing deep-frozen desserts having creaminess and softness characteristics at temperatures preferably between −15° C. and −25° C., and that does not contain any ingredients that may cause in the finished product an unpleasant aftertaste for the consumer.

A further object is that the semi-processed product of the invention should simplify and reduce the preparation time of deep-frozen desserts.

Another object is that the semi-processed product and the deep-frozen dessert that is made with said semi-processed product contain in very low quantities ingredients that have a laxative effect or are difficult to digest, in order not to cause the consumer said laxative effects or digestive difficulties.

Not the last object is that the semi-processed product and the deep-frozen dessert should show compactness and structural stability characteristics without the need of adding stabilizers.

Said objects are obtained by a semi-processed product for preparing deep-frozen desserts having creaminess and softness characteristics at temperatures below zero, preferably between −15° C. and −25° C., which, in accordance with the main claim, comprises:
monosaccharides in a percentage range between 60% and 80%;
sweeteners in a percentage range between 5% and 15%;
milk proteins in a percentage range between 5% and 10%,
   and is characterized by also comprising vegetable fibres in a percentage range between 0.5% and 10%, said percentage values being based on the total weight of the semi-processed product.

According to an executive embodiment, the semi-processed product is made of a solid mixture of granular or powdery texture.

According to another executive embodiment, the semi-processed product is made of a pasty mixture obtained by kneading the granular or powder mixture with water.

The semi-processed product may be packaged, stored, marketed and used in any of the two executive embodiments in line with the producer's and/or consumer's choice.

The vegetable fibres are made of fruit extracts, in particular of lemon or apple extracts.

In order to make the dessert, the semi-processed product is mixed with further ingredients that define the characteristics of the finished product in terms of taste, colour, texture and so on.

Advantageously, the vegetable fibres, mixed with the sweeteners, give the dessert the creamy and soft texture also when deep-frozen, so that it may be served and enjoyed as soon as it is removed from the freezer.

Also as an advantage, the ingredients that make up the semi-processed product are gathered in a single mixture of granular texture, in powder or in paste form, in order to be handled as a single ingredient and thus simplifying the process of preparing deep-frozen desserts.

Still advantageously, the addition of vegetable fibres adds the characteristics of smoothness and softness to the product thus reducing the quantity of polyols to such a level that it does not create dangerous laxative effects or digesting troubles for the consumer.

The foregoing objects and advantages will be better understood by the following description of preferred executive embodiments of the invention given as an illustrative, but non-limiting example.

The semi-processed product of the invention consists of a selection of functional ingredients which are the basis for making the finished deep-frozen product.

More particularly, the ingredients that make up the semi-processed product of the invention comprise:
monosaccharides in a percentage range between 60% and 80%;
sweeteners in a percentage range between 5% and 15%;
milk proteins in a percentage range between 5% and 10%;
vegetable fibres in a percentage range between 0.5% and 10%,
   in which the said values show, for each ingredient, the range of variation in percentage of use, on the basis of the total weight of the semi-processed product.

According to a preferred executive embodiment and method, the semi-processed product has the following composition:
monosaccharides about 78%;
sweeteners about 12%;
milk proteins about 9%;
vegetable fibres about 1%,
   of which the said values indicate, for each ingredient, the value of use in percentage in relation to the total weight of the semi-processed product.

According to another executive embodiment and method, the semi-processed product has the following composition:
monosaccharides about 78%;
sweeteners about 9%;
milk proteins about 9%;
vegetable fibres about 4%.

As regards the milk proteins, these are produced with dairy products, for instance low-fat milk, full-fat milk, unrefined milk substitutes or blends thereof.

As far as the sweeteners are concerned, however, these are made of polyols like mannitol, sorbitol or maltitol and mixtures thereof. It is preferable to use sorbitol.

Regarding the monosaccharides, these are made of dextrose, glucose, fructose or mixtures thereof.

The vegetable fibres, according to the invention, consist of fruit extracts, preferably lemon or apple extracts.

It is the presence of the vegetable fibres that, mixed with the sweeteners and therefore with the polyols, give the dessert the creamy and soft texture also when deep-frozen.

Therefore, once the dessert is removed from the freezer, it is possible to cut it into serving portions, to serve it and eat it.

The existence of vegetable fibres does, however, allow to reduce the quantity of the polyols to very low values and, therefore, the finished product does not have the negative side effects of being difficult to digest and being laxative, as can be experienced with known products in which said polyols are present in larger quantities.

Furthermore, the existence of vegetable fibres improves the compactness and structural resistance of the product after removing it from the freezer and therefore keeps its compactness and structural resistance for a longer period of time compared to similar products that use stabilizers like guar, carob, alginates, carrageenan and others.

Finally, the presence of said vegetable fibres allows to eliminate the vegetable oils and therefore the possibility that the finished product may have unwanted aftertastes.

The semi-processed product of the invention may be produced, marketed and used in powder or granular form or in the form of a paste obtained with the addition of water.

At the manufacturing stage of the dessert, the semi-processed product will be treated as if it were a single ingredient.

Alternatively, the dessert may be prepared using separately the ingredients that make up the semi-processed product of the invention.

The semi-processed product of the invention can be used to produce different deep-frozen desserts using different semi-processed quantities that are mixed with different ingredients.

Therefore, for example, a recipe suitable for preparing a deep-frozen dessert that consists of a mousse requires the following composition:
semi-processed product about 11%;
whipped cream about 51%;
sugar about 37%;
gelatine about 1%,
   the percentage values of each ingredient being in relation to the total weight of the finished product.

As concerns the semi-processed product, the percentage listed to the right refers to any one of the aforementioned compositions.

Similarly, a suitable recipe for preparing vanilla ice-cream requires the following composition:
semi-processed product about 6%;
milk about 58.5%;
sugar about 16%;
whipped cream about 12%;
egg yolk about 7%;
stabilizers about 0.5%.

Another recipe suitable for preparing cream flavoured ice-cream requires the following composition:
semi-processed product about 8%;
milk about 62.5%;
whipped cream about 16%;
sugar about 13%;
stabilizers about 0.5%.

A recipe suitable for obtaining custard requires the following composition:
semi-processed product about 11%;
butter about 54%;
sugar about 15%;
eggs about 13%;
milk about 7%.

In a similar way, different recipes for making deep-frozen desserts, different from those just listed, may be composed.

Anyway, it is totally clear that any one of the described deep-frozen desserts may be prepared also by mixing the ingredients that make up the semi-processed product individually. In that case though, the production time will be longer since the ingredients have to be mixed after having been picked and weighed individually.

Based on what has been said and described, first of all it is clear that the semi-processed product of the invention obtains the scope of simplifying the process of preparing deep-frozen desserts since, during the preparation of the mixture, the ingredients combined in the semi-processed product may be used as a single ingredient.

Furthermore, the deep-frozen dessert that is made with the above-mentioned semi-processed product is soft enough to be served and eaten as soon as it is removed from the freezer.

Although containing polyols, their quantity in the dessert is so low as not to cause the disagreeable laxative effects or difficulty in digestion for the consumer, even if the desserts are eaten in large quantities.

Finally, the absence of vegetable oils and stabilizers makes it possible to obtain a product without aftertaste and of high compactness.

A fact which has already been mentioned and that is clearly evident is that any one of the described deep-frozen desserts may also be obtained by individually combining the ingredients, which make up the semi-processed product of the invention.

Any modifications to the semi-processed product or to the deep-frozen dessert regarding what has been described and illustrated, within the scope of the following claims, should certainly be protected by the present patent.

1) A semi-processed product for the preparation of deep-frozen desserts having creamy and soft characteristics at temperatures below zero, preferably in a range between −15° C. and −25° C., comprising:
monosaccharides in percentage ranging between 60% and 80%;
sweeteners in percentage ranging between 5% and 15%;
milk proteins in percentage ranging between 5% and 10%,
characterized by comprising also vegetable fibres in percentage ranging between 0.5% and 5%, said percentage values being based on the total weight of the semi-processed product.

2) The semi-processed product according to claim 1) characterized in that it requires the following composition:
monosaccharides about 78%;
sweeteners about 12%;
milk proteins about 9%;
vegetable fibres about 1%,
wherein the said values show, for each ingredient, the percentage value of use in relation to the total weight of the semi-processed product.

3) The semi-processed product according to claim 1) characterized in that it requires the following ingredients:
monosaccharides about 78%;
sweeteners about 9%;
milk proteins about 9%;
vegetable fibres about 4%,
wherein the said values show, for each ingredient, the percentage value of use in relation to the total weight of the semi-processed product.

4) The semi-processed product according to any one of claims 1), 2) or 3), characterized in that said vegetable fibres are fruit extracts.

5) The semi-processed product according to claim 4) characterized in that said fruit extracts are lemon extracts.

6) The semi-processed product according to claim 4) characterized in that said fruit extracts are apple extracts.

7) The semi-processed product according to any one of claims 1), 2) or 3) characterized in that said monosaccharides are dextrose, or glucose, or fructose or blends thereof.

8) The semi-processed product according to any one of claims 1), 2) or 3) characterized in that said sweeteners are polyhydric alcohols or polyols.

9) The semi-processed product according to claim 8) characterized in that said polyhydric alcohols or polyols are mannitol, or sorbitol, or maltitol or blends thereof.

10) The semi-processed product according to any one of claims 1), 2) or 3) characterized in that said milk proteins are derived from products of dairy origin.

11) The semi-processed product according to any one of the preceding claims characterized by being in granular form.

12) The semi-processed product according to any one of the preceding claims characterized by being in powder form.

13) The semi-processed product according to any one of the preceding claims characterized by being in form of a paste.

14) A deep-frozen dessert characterized in that it comprises:
semi-processed product according to any one of the claims from 1) to 3) about 11%;
whipped cream about 51%;
sugar about 37%;
gelatine about 1%,
the percentage values of each ingredient being based on the total weight of the finished product.

15) A deep-frozen dessert characterized in that it comprises:
semi-processed product according to any one of the claims from 1) to 3) about 6%;
milk about 58.5%;
sugar about 16%;
whipped cream about 12%,
egg yolk about 7%,
stabilizers about 0.5%,
the percentage values of each ingredient being based on the total weight of the finished product.

16) A deep-frozen dessert characterized in that it comprises:
semi-processed product according to any one of the claims from 1) to 3) about 8%;
milk about 62.5%;
whipped cream about 16%;
sugar about 13%,
stabilizers about 0.5%,
the percentage values of each ingredient being based on the total weight of the finished product.

17) A deep-frozen dessert characterized in that it comprises:
semi-processed product according to any one of the claims from 1) to 3) about 11%;
butter about 54%;
sugar about 15%;
eggs about 13%,
milk about 7%,
the percentage values of each ingredient being based on the total weight of is the finished product.
